(19) United States
(12) Patent Application Publication
(10) Pub. No.: US 2018/0232794 A1
(43) Pub. Date: Aug. 16, 2018

(54) METHOD FOR COLLABORATIVELY FILTERING INFORMATION TO PREDICT PREFERENCE GIVEN TO ITEM BY USER OF THE ITEM AND COMPUTING DEVICE USING THE SAME

(71) Applicant: Idea Labs Inc., Seoul (KR)

(72) Inventors: Yong Dai Kim, Seoul (KR); Min Soo Kang, Seoul (KR); Jae Sung Hwang, Seoul (KR)

(21) Appl. No.: 15/672,625

(22) Filed: Aug. 9, 2017

(30) Foreign Application Priority Data
Feb. 14, 2017 (KR) 10-2017-0020234

(51) Int. Cl. G06Q 30/06; G06Q 30/02; G06F 17/16

(52) U.S. Cl. CPC G06Q 30/0631; G06F 17/16; G06Q 30/02

(57) ABSTRACT

A method for filtering information to predict values of preference given to items by users is provided. The method includes steps of: (a) acquiring data rᵤᵢ as the value of preference given by each of individual users u regarding each of individual items i; (b) obtaining estimators [symbol] of means μᵤᵢ=α₀+αᵢ^{I}+αᵤ^{U} by estimating α₀,αᵢ^{I},αᵤ^{U} (u∈U, i∈I) that minimize

$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ;$$

(c) calculating residuals rᵤᵢ− [symbol] by using the estimators [symbol] of the means μᵤᵢ; (d) estimating spreads σᵤ² of the values of the preference by individual users by using the residuals; (e) estimating matrices Φ by using the residuals; (f) calculating covariance matrices Σᵤ=σᵤ²Φ; and (g) calculating B(Rᵤᵢ|Rᵤⱼ=rᵤⱼ,(u,j)∈R) which is a conditional expectation value of Rᵤᵢ that is estimated preference data of a specific user u regarding the each item i.

### CROSS REFERENCE TO RELATED APPLICATION

This application claims priority to and incorporates herein by reference all disclosure in Korean Patent Application No. 10-2017-0020234 filed Feb. 14, 2017.

### FIELD OF THE INVENTION

The present invention relates to a method for filtering information to predict one or more values of preference given to one or more items by one or more users and a computing device using the same, and more particularly, to the method for acquiring data rᵤᵢ as the values of the preference that have been given by each individual user it to each individual item i; obtaining one or more estimators [symbol] of one or more means μᵤᵢ=α₀+αᵢ^{I}+αᵤ^{U} by estimating α₀,αᵢ^{I},αᵤ^{U} (u∈U, i∈I) that minimize

$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ;$$

calculating residuals rᵤᵢ− [symbol] by using the estimators [symbol] of the means μᵤᵢ by estimating spreads σᵤ² of the values of the preference by each individual user u by using the residuals; estimating matrices ϕ; calculating covariance matrices Σᵤ=σᵤ²Φ; and calculating E(Rᵤᵢ|Rᵤⱼ=rᵤⱼ, (u,j)∈R) which are conditional expectation values of Rᵤᵢ that are estimated preference data of a specific user it regarding at least one of the each individual item i among the individual items, wherein U indicates a set of the individual users; I is a set of the individual items; r; refer to observed values of Rᵤᵢ as random variables that represent the values of the preference given to the each individual item i by the each individual user u; λ_{U} is a tuning parameter of U; and λ_{I} is a tuning parameter of I and the computing device using the same.

### BACKGROUND OF THE INVENTION

Definition of Recommender System

A recommender system RS is a term indicating software technology and tools that suggest one or more items to be used by one or more users. This is about a variety of courses for decision, e.g., courses for deciding which item will be purchased, which kind of music will be listened to, or which online news article will be read. The term ‘item’ used here is a general term that refers to a subject recommended to users by the recommender system, and includes any kinds of subjects that are capable of being selected by the users, regardless of types, tangibility, or specificity of products.

Because the recommender system generally focuses on items of a specific type, a design, a graphical user interface, and a core recommendation technology of the recommender system are customized to provide useful and effective suggestions of such a specific type of items.

According to the more academic definition, the recommender system refers to a subclass of information filtering system that seeks to predict rating or preference that a user would give to an item such as a song, a book, or a movie or to a social element such as people or personal connections, and it uses a model established based on characteristics of such items or a user's social environment. The former approach that considers the characteristics of the items is called as a content-based filtering approach and the latter one that considers the social environment is called as a collaborative filtering approach. In general, the collaborative filtering approach is based on preference data that have already been given by evaluation.

The recommender system as a concept has been realized for industrial purposes when it became possible to acquire a large amount of preference information through media such as the Internet. Because traditional street-side stores which did not use the Internet, so-called “brick and mortar” stores, could not acquire the large amount of preference information, it was impossible for them to reasonably predict the rating or the preference of a specific user only by referring to limited information on the rating or the preference (so-called long tail phenomenon). Only after the Internet became popular, a variety of recommendation methods have been developed and applied to practice over the past 10 years.

Conventional Content-Based Filtering Approach

The content-based filtering approach as stated above is a method for acquiring information on first items preferred by a user and recommending second items to the user by referring to first items. In this case, it is important to measure similarities between the first and the second items.

One of the content-based approaches is a Term Frequency Inverse Document Frequency, i.e., TF-IDF, method. This is a method for quantifying contents of individual items in case the contents are expressed as a text. Herein, Term Frequency, i.e., TF, is as follows:

$$TF ( i , k ) = \frac{freq ( i , k )}{max Others ( i , k )} ,$$

wherein freq(i, k) is a frequency of occurrence of a keyword i included in a k-th document; and max Others(i, k) is a maximum frequency of occurrence of keywords included in the k-th document with the keyword i excluded. In addition, Inverse Document Frequency, i.e., IDF, is as follows:

$$IDF ( i ) = log \frac{N}{n ( i )} ,$$

wherein N is the number of all documents, i.e., the number of items; and n(i) is the number of documents including the keyword i. If a certain keyword frequently appears in several documents, it may be necessary to regard it as insignificant. For example, a keyword such as a definite article “the” is insignificant. Thus, the IDF(i) factor expresses this reasoning. Now, the TF-IDF that considers both TF and IDF is as follows:

TP-IDF(i,k)=TF(i,k)×IDP(i)

The TF-IDF vector for each item may be formed by using all keywords provided in corresponding documents. With the TF-IDF vector, similarity between items may be measured. The Pearson correlation coefficient or the cosine distance may be mainly used to measure the similarity.

The advantages of the content-based approach are that it does not require other users' information or values of preference and that it is capable of immediately recommending newly added items without collecting additional statistical data. However, the content-based approach can only deal with characteristics expressed in a form of document and does not detect implicit context well enough. Besides, recommendation may be limited to items of a similar type (or genre). For example, the recommender system may recommend romance movies only to users who like romance movies.

Conventional Collaborative Filtering Approach

Lately, the collaborative filtering approach is more widely used than the content-based approach. The collaborative filtering approach can recommend a variety of items beyond the boundary of the type of a specific item because it recommends items based only on statistical correlations of values of the preference among items. For example, according to the collaborative filtering approach, it may be possible to recommend a specific vehicle instead of movies to users who like romance movies.

The collaborative filtering approach can be classified into a nearest neighborhood (NN) technique and a matrix factorization (MF) technique. The MF technique is preferred to the NN technique because the MF technique shows a more excellent predictive accuracy as well as a better interpretation ability and a greater scalability compared to the NN technique. In particular, a recommender system which was developed based on the MF technique won the prize in Netflix competition of recommender systems in the past. Now, the MF technique is a de facto mainstream technique of the preference-based recommender systems.

But even the MF technique has following serious weaknesses:

First, it performs optimization repeatedly to estimate parameters. If there are a great number of data, the computational load increases considerably. In particular, a tremendous computation is required by reflecting additional information, e.g., customers' demographic information, etc. beside values of preference, or contextual information. For example, the contextual information may include information on a place where a movie is watched, because a value of preference of the movie watched at home and that of the movie watched at a theater are different.

Second, the predictive power of the MF technique is not optimal. The recommender system basically seeks a better predictive accuracy but a type of method optimized for such a predictive accuracy is a regression model. In comparison, the MF technique is a method for factor analysis in statistics, and it is a widely-known fact that the factor analysis is not optimized for the predictive accuracy.

Therefore, the inventor intends to suggest a method and a device for configuring a recommender system that may reduce computational load while having excellent performance compared to the conventional methods.

### SUMMARY OF THE INVENTION

It is an object of the present invention to solve weaknesses of the conventional recommender systems as stated above.

More specifically, it is an object of the present invention to predict items preferred by applying regression models different for individual users. The method is called as a personalized regression (PR) method. Under the assumption that information on values of preference of several items by individuals follows multivariate normal distribution, the PR method estimates means and variances which are parameters of the multivariate normal distribution by using moment estimators, and establishes a personalized regression model based thereon. In particular, the regression models different for individual users are applied because there are different types of products preferred by individuals.

In accordance with one aspect of the present invention, there is provided a method for filtering information to predict one or more values of preference given to one or more items by one or more users, including steps of: (a) a computing device acquiring data rᵤᵢ as the value of preference that has been given by each of individual users u regarding each of individual items i; (b) the computing device obtaining one or more estimators [symbol] of one or more means μᵤᵢ=α₀+αᵢ^{I}+αᵤ^{U} by estimating α₀,αᵢ^{I},αᵤ^{U} (u∈U, i∈I) that minimize

$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ,$$

wherein U indicates a set of the individual users; i is a set of the individual items; rᵤᵢ refers to each of observed values of Rᵤᵢ as random variables that represent the values of the preference given to the each item i by the each user u; λ_{U} are tuning parameters of U; and λ_{I} are tuning parameters of I; (c) the computing device calculating residuals rᵤᵢ− [symbol] by using the estimators [symbol] of the means μᵤᵢ; (d) the computing device estimating spreads σᵤ² of the values of the preference by individual users by using the residuals; (e) the computing device estimating matrices Φ by using the residuals; (f) the computing device calculating covariance matrices Σᵤ=σᵤ²Φ; and (g) the computing device calculating B(Rᵤᵢ|Rᵤⱼ=rᵤⱼ,(u,j)∈R) which is a conditional expectation value of Rᵤᵢ that is estimated preference data of a specific user u regarding the each item i.

In accordance with another aspect of the present invention, there is provided a computing device for filtering information to predict one or more values of preference given to one or more items by one or more users, including: a communication part for acquiring data rᵤᵢ as the value of the preference which has been given by each of individual users u regarding each of individual items i; and a processor for (i) obtaining estimators [symbol] of one or more means μᵤᵢ=α₀+αᵢ^{I}+αᵤ^{U} by estimating α₀,αᵢ^{I},αᵤ^{U} (u∈U, i∈I) that minimize

$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ,$$

wherein U indicates a set of the individual users; I is a set of the individual items; rᵤᵢ refers to each of observed values of Rᵤᵢ as random variables that represent the values of the preference given to the each item i by the each user u; λ_{U} are tuning parameters of U; and λ_{I} are tuning parameters of I; (ii) calculating residuals rᵤᵢ− [symbol] by using the estimators [symbol] of the means μᵤᵢ; (iii) estimating spreads σᵤ² of the values of the preference by individual users by using the residuals; (iv) estimating matrices Φ by using the residuals; (v) calculating covariance matrices Σᵤ=σᵤ²Φ; and (vi) calculating B(Rᵤᵢ|Rᵤⱼ=Rᵤⱼ,(u,j)∈R) which is a conditional expectation value of Rᵤᵢ that is estimated preference data of a specific user u regarding the each item i.

### BRIEF DESCRIPTION OF THE DRAWINGS

The drawings attached below to explain example embodiments of the present invention are only part of example embodiments of the present invention and other drawings may be obtained based on the drawings without inventive work for those skilled in the art:

FIG. 1 is a block diagram schematically representing an exemplary configuration of a computing device that performs a method for filtering information to predict a value of preference given to one or more items by one or more users in accordance with the present invention.

FIG. 2 is a flow chart exemplarily illustrating a method for filtering information to predict values of preference given to the items by the users in accordance with the present invention.

FIG. 3 is a drawing conceptually illustrating a nearest neighbor technique as a method for recommending items that a specific user is expected to prefer among products preferred by users whose corresponding values of preference for items are similar to those of the specific user.

FIG. 4 is a diagram schematically showing a matrix factorization (MF) technique.

FIG. 5 is a diagram illustrating one detailed example embodiment to which the MF technique is applied.

FIG. 6 is a diagram schematically showing a method for decomposing multi-dimensional tensors in a multiverse recommender system.

FIG. 7 is a diagram showing one example embodiment to which a recommender system with a factorization machine is applied.

### DETAILED DESCRIPTION OF THE PREFERRED EMBODIMENTS

Detailed explanations of the present invention explained below refer to attached drawings that illustrate specific embodiment examples of this present that may be executed. These embodiments are described in sufficient detail to enable those skilled in the art to practice the invention.

In addition, a term “include” and its variants are not intended to exclude other technical features, additions, components, and steps over the detailed explanations and claims of the present invention. Some of other purposes, advantages, and characteristics of the present invention will be revealed to those skilled in the art partly from this explanation and others from the execution of the present invention. The following examples and drawings are provided as examples and are not intended to limit the present invention.

Furthermore, the present invention covers all possible combinations of example embodiments indicated in this specification. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention.

In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Unless otherwise indicated herein or clearly to the contrary to the context, items indicated in singular, unless otherwise required by the context, encompass those in plural. To allow those skilled in the art to easily execute the present invention, detailed explanation will be given by referring to the attached drawings regarding the desired example embodiments of the present invention.

Some example embodiments of the present invention may be implemented in e-commerce systems and/or other recommender systems for transaction that are currently known or to be developed. The recommender systems in the present invention typically achieve desired system performance by using combinations of computer hardware (e.g., computer processor, memory, storage, input and output devices, and client computers and server computers that may include components of other existing computer systems; electronic communications devices such as electronic communications cables, routers, and switches; and electronic information storage systems such as network-attached storage (NAS) and storage area network (SAN)) and computer software (i.e., instructions that allow computer hardware to function in a specific way).

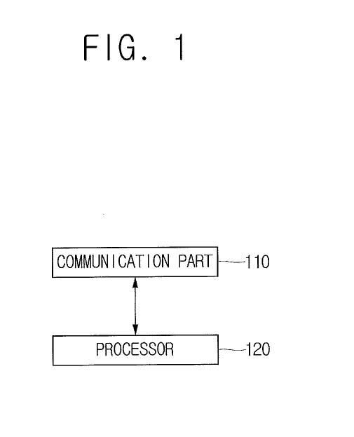

FIG. 1 is a conceptual diagram schematically representing an exemplary configuration of a computing device that performs a method for filtering information to predict a value of preference given to an item by a user in accordance with the present invention.

In FIG. 1, a computing device 100 includes a communication part 110 and a processor 120. The computing device 100 may acquire data and provide users with desired recommendation information by processing the data. To be explained below, it will be easily understood by those skilled in the art that the method of the present invention may be implemented by using combinations of computer hardware and software and that the computing device 100 may implement methods explained as shown below.

Nearest Neighbor Technique

The nearest neighbor (NN) technique is a method for analyzing values of preference of individual users and histories of items selected by them in the past, and recommending optimal items to the individual users.

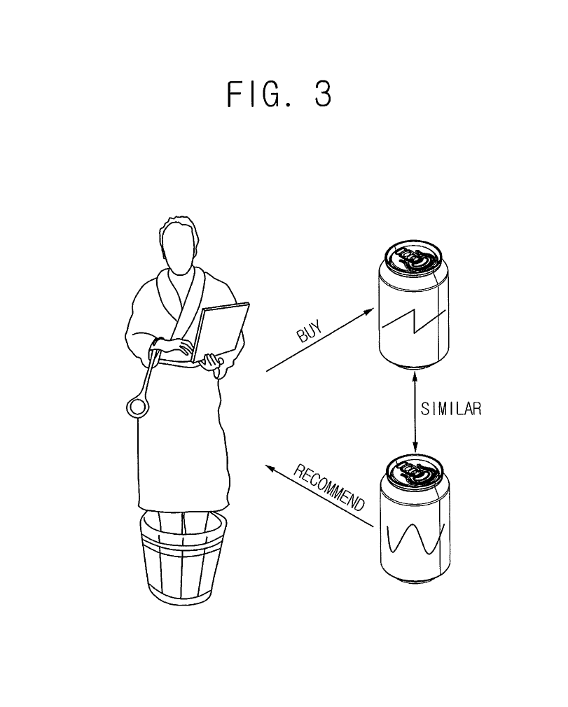

FIG. 3 is a drawing conceptually illustrating the nearest neighbor technique as a method for recommending items that a specific user is expected to prefer among products preferred by users whose corresponding values of preference for the items are similar to those of the specific user.

The NN technique includes a user-based collaborative filtering approach and an item-based collaborative filtering approach. For convenience of explanation, only the item-based collaborative filtering approach will be disclosed herein.

What the NN technique first performs is a step of measuring similarities of preference patterns between customers. Herein, rᵤᵢ is a value of preference of a u-th user for an i-th item; Oᵢⱼ is a set of all users whose values of preference for items i and j have been observed; and r̅ᵢ̅ and r̅ⱼ̅ indicate average of the values of preference observed for the items i and j. For all methods to be introduced below, the same notation will be used. A similarity between the items i and j, i.e., s(i,j), may be calculated by using the Pearson correlation coefficient or cosine distance similarity. The Pearson correlation coefficient is expressed as

$${s}^{I} ( i , j ) = \frac{{\sum }_{u ∈ {O}_{ij}}^{ } ( {r}_{ui} - \overline{{r}_{i}} ) ( {r}_{uj} - \overline{{r}_{j}} )}{\sqrt{{\sum }_{u ∈ {O}_{ij}}^{ } {( {r}_{ui} - \overline{{r}_{i}} )}^{2}} \sqrt{{\sum }_{u ∈ {O}_{ij}}^{ } ( {r}_{uj} - \overline{{r}_{j}} )}} ,$$

and the cosine distance similarity is expressed as

$${s}^{I} ( i , j ) = \frac{{\sum }_{u ∈ {O}_{ij}} {r}_{ui} {r}_{uj}}{\sqrt{{\sum }_{u ∈ {O}_{ij}} {r}_{ui}^{2}} \sqrt{{\sum }_{u ∈ {O}_{ij}} {r}_{uj}^{2}}} .$$

The next step of the NN technique is estimating unobserved values of preference, by using the calculated similarity. The notations herein are as follows:

R={(u,i):rᵤᵢ is observed}, and

R_{I}(u)={i:rᵤᵢ is observed}.

Besides, R_{I}^{k}(i:u) refers to a set of top k items which have high similarities to the item i among the items belonging to R_{I}(u). The unobserved values of preference may be estimated by using items whose preference patterns are similar to that of the item i. The estimates may be expressed as follows:

$${\hat{r}}_{ui} = {μ}_{ui} + \frac{{\sum }_{j ∈ {R}_{I}^{k} ( i \text{:} U )} ( {r}_{uj} - {μ}_{uj} )}{\vert {R}_{I}^{k} ( i \text{:} u ) \vert} ,$$

wherein μᵤᵢ=μ₀+μᵤ^{U}+μᵢ^{I} or

$${\hat{r}}_{ui} = {μ}_{ui} + \frac{{\sum }_{j ∈ {R}_{I}^{k} ( i \text{:} u )} {s}^{I} ( i , j ) ( {r}_{uj} - {μ}_{uj} )}{{\sum }_{j ∈ {R}_{I}^{k} ( i \text{:} u )} \vert {s}^{I} ( i , j ) \vert} .$$

Now, μᵤᵢ must be estimated. The value that minimizes

$${\sum }_{( u , i ) ∈ R} {( {r}_{ui} - {μ}_{0} - {μ}_{u}^{U} - {μ}_{i}^{I} )}^{2} + {λ}_{U} \vert \vert {μ}^{U} {\vert \vert}^{2} + {λ}_{I} \vert \vert {μ}^{I} {\vert \vert}^{2}$$

may be estimated as (μ₀,μ^{U},μ^{I}), wherein ∥⋅∥ is an operator that indicates the Euclidean distance. Specifically, explanation with following examples will be made:

TABLE 1

| | | | | Forrest | |
|---|---|---|---|---|---|
| | Matrix | Titanic | Die Hard | Gump | Wall-E |
| John | 5 | 1 | 2 | 2 | |
| Lucy | 1 | 5 | 2 | 5 | 5 |
| Eric | 2 | ? | 3 | 5 | 4 |
| Diana | 4 | 3 | 5 | 3 | |

Suppose Forrest Gump and Wall-E are two movies with the highest similarities to Titanic in Table 1. Assume that the similarity between Titanic and Forrest Gump is 0.85, and the similarity between Titanic and Wall-E is 0.75. When k=2,

$$\hat{r} = \frac{0.85 \times 5 + 0.75 \times 4}{0.85 + 0.75} = 4.53 .$$

It was assumed that all of (μ₀,μ^{U},μ^{I}) were estimated as 0.

The NN technique has a weakness that it is difficult to measure similarities when there is data sparsity. In other words, there are many cases in which it is difficult to measure similarities because there are only a small number of users who have evaluated both of values of preference for two items. In addition, the NN technique is difficult to use customers' demographic information or information on contents of items for analysis. Besides, it is difficult to recommend new items, or items to new users. This is also called a cold start problem. An alternative to this is adopting a collaborative filtering approach by using a regression model.

Global Neighborhood Technique

A global neighborhood technique is an improvement on the conventional collaborative filtering approach. In the conventional collaborative filtering approach, an equation for predicting the values of preference may be written as follows:

$${\hat{r}}_{ui} = {μ}_{ui} + \frac{{\sum }_{j ∈ {R}_{I}^{k} ( i \text{:} u )} {s}^{I} ( i , j ) ( {r}_{uj} - {μ}_{uj} )}{{\sum }_{j ∈ {R}_{I}^{k} ( i \text{:} u )} \vert {s}^{I} ( i , j ) \vert} = {μ}_{ui} + {\sum }_{j ∈ {R}_{I}^{k} ( i \text{:} u )} {ω}_{ij}^{u} ( {r}_{uj} - {μ}_{uj} ) ,$$

wherein

$${ω}_{ij}^{u} = \frac{{s}^{I} ( i , j )}{{\sum }_{j ∈ {R}_{I}^{k} ( i \text{:} u )} \vert {s}^{I} ( i , j ) \vert} .$$

To make this simpler, R_{I}^{k}(i:u) is changed to R_{I}(u) and wᵢⱼ^{u} is replaced with ωᵢⱼ, then the equation becomes as follows:

$${\hat{r}}_{ui} = {μ}_{ui} + {\sum }_{j ∈ {R}_{I} ( u )} {ω}_{ij} ( {r}_{uj} - {μ}_{uj} ) , \qquad ( 1 )$$

wherein μᵤᵢ=μ₀+μᵢ^{I}+μᵤ^{U}.

Now, to get \hat{r}ᵤᵢ, parameters μ₀,μᵢ^{I},μᵤ^{U} and ωᵢⱼ must be estimated. The method of estimation is as shown below. First of all, μ₀,μᵢ^{I},μᵤ^{U} (u∈U, i∈I) that minimize

$${\sum }_{( u , i ) ∈ R} {\{ {r}_{ui} - {μ}_{0} - {μ}_{i}^{I} - {μ}_{u}^{U} \}}^{2} + {λ}_{U} {\sum }_{u} {μ}_{u}^{{U}^{2}} + {λ}_{I} {\sum }_{i} {μ}_{i}^{{I}^{2}}$$

are estimated, wherein λ_{U} and λ_{I} are tuning parameters. After the estimated values μ₀,μᵢ^{I},μᵤ^{U} are substituted into the equation (1), ωᵢⱼ (i,j∈I) that minimize

$${\sum }_{( u , i ) ∈ R} {\{ {r}_{ui} - {\hat{r}}_{ui} \}}^{2} + {λ}_{W} {\sum }_{i , j} {ω}_{ij}^{2}$$

are estimated, wherein λ_{w} is a tuning parameter. The tuning parameters stated herein may be obtained through cross validation. As the method for obtaining such tuning parameters is well-known to those skilled in the art, more detailed explanation will be omitted. Thus, \hat{r}ᵤᵢ may also be obtained.

Weighted Global Neighborhood Technique

A weighted global neighborhood technique is a slightly modified form of the global neighborhood technique. It was experimentally proved to produce better performance. The model equation of the weighted global neighborhood technique is as follows:

$${\hat{r}}_{ui} = {μ}_{ui} + \vert {R}_{I} ( u ) {\vert}^{- 1 \text{/} 2} {\sum }_{j ∈ {R}_{I} ( u )} {ω}_{ij} ( {r}_{uj} - {μ}_{uj} ) , \qquad ( 2 )$$

wherein μᵤᵢ=μ₀+μᵢ^{I}+μᵤ^{U}.

The method for estimating parameters of the weighted global neighborhood technique is identical to that of the global neighborhood technique. Once again, μ₀,μᵢ^{I},μᵤ^{U} (u∈U,i∈I) that minimize

$${\sum }_{( u , i ) ∈ R} {\{ {r}_{ui} - {μ}_{0} - {μ}_{i}^{I} - {μ}_{u}^{U} \}}^{2} + {λ}_{U} {\sum }_{u} {μ}_{u}^{{U}^{2}} + {λ}_{I} {\sum }_{i} {μ}_{i}^{{I}^{2}}$$

are estimated, wherein λ_{U} and λ_{I} are tuning parameters. After the estimated values μ₀,μᵢ^{I},μᵤ^{U} are substituted into the equation (2), ωᵢⱼ (i,j∈I) that minimize

$${\sum }_{( u , i ) ∈ R} {\{ {r}_{ui} - {\hat{r}}_{ui} \}}^{2} + {λ}_{W} {\sum }_{i , j} {ω}_{ij}^{2}$$

are estimated, wherein λ_{W} is a tuning parameter.

The trouble with the global neighborhood technique and the weighted global neighborhood technique is that there are a lot of parameters. The number of parameters amounts to the square of the number of items. In addition, it is still difficult to estimate parameters when there is data sparsity.

Matrix Factorization Technique

A matrix factorization (MF) technique is a method for factorizing a preference matrix into two matrices and predicting values of preference that have not been evaluated.

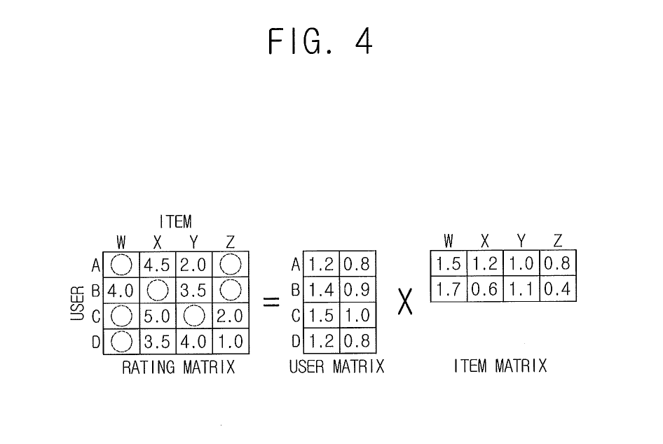

FIG. 4 is a diagram that schematically shows a matrix factorization technique.

By referring to FIG. 4 as an example, a preference matrix (or a rating matrix) is illustrated on the left and it is expressed as the product of a user matrix corresponding to the users and an item matrix corresponding to the items. Through the factorization, the values of preference to be inserted in dotted circles could be predicted.

A model equation under the MF technique may be as follows:

\hat{r}ᵤᵢ=μᵤᵢ+ϕᵤ^{U′}ϕᵢ^{I}, and

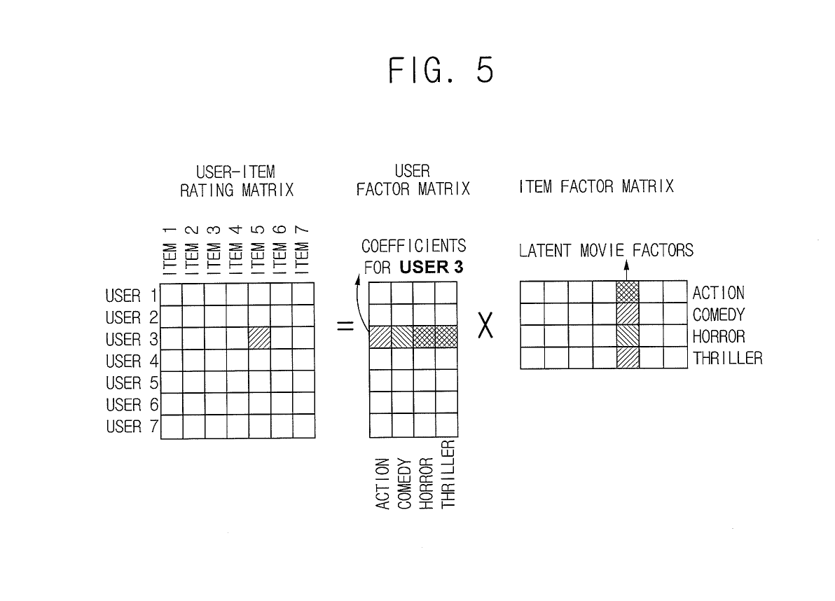

μᵤᵢ=μ₀+μᵢ^{I}+μᵤ^{U},

wherein ϕᵤ^{U}(∈ [symbol] ^{k}) indicates values of preference of a user it regarding latent factors of k items; and ϕᵢ^{I}(∈ [symbol] ^{k}) indicates a degree of the item i regarding latent factors of the k items. To take an instance for explanation, when the item is a movie, the latent factor of the item may be interpreted as a genre of movie. For reference, matrix factorization is roughly illustrated in FIG. 5. By referring to FIG. 5, a genre of an action, a genre of a comedy, a genre of a horror, and a genre of a thriller correspond to each row or each column of a user factor matrix and an item factor matrix. Such genre information is not given in advance but obtained by analyzing individual matrices, i.e., the user factor matrix and the item factor matrix.

A parameter estimation method under the MF technique is as follows:

First of all, μ₀,μᵢ^{I},μᵤ^{U} (u∈U, i∈I) that minimize

$${\sum }_{( u , i ) ∈ R} {\{ {r}_{ui} - {μ}_{0} - {μ}_{i}^{I} - {μ}_{u}^{U} \}}^{2} + {λ}_{U} {\sum }_{u} {μ}_{u}^{{U}^{2}} + {λ}_{I} {\sum }_{i} {μ}_{i}^{{I}^{2}}$$

are estimated, wherein λ_{U} and λ_{I} are tuning parameters. Next, ϕᵤ^{U},ϕᵢ^{I} that minimize

$${\sum }_{\{ u , i \} ∈ R} {\{ {r}_{ui} - {\hat{r}}_{ui} \}}^{2} + {λ}_{{U}^{2}} {\sum }_{u} \vert \vert {φ}_{u}^{U} {\vert \vert}^{2} + {λ}_{{I}^{2}} {\sum }_{i} \vert \vert {φ}_{i}^{I} {\vert \vert}^{2}$$

are estimated by substituting the estimated μ₀,μᵢ^{I},μᵤ^{U} into the formula, wherein ∥⋅∥ is set to make ∥ν∥²=∥₁²+ν₂²+ . . . +νₚ² when ν=(ν₁, ν₂, . . . νₚ)^{T}∈ [symbol] ^{p}.

The MF technique is preferred to the NN technique in several aspects because the MF technique has a more excellent predictive accuracy as well as a better interpretative ability and a greater scalability compared to the NN technique. In particular, the recommender system developed based on the MF won the prize in Netflix competition of recommender systems in the past. Now, the MF technique is a de facto mainstream technique of the preference-based recommender systems.

Hybrid Technique

A hybrid technique is a method combining both the method using the regression model and the matrix factorization technique. A model equation under the MF technique is as follows:

\hat{r}ᵤᵢ=μᵤᵢ+ϕᵤ^{U′}ϕᵢ^{I}; and

μᵤᵢ=μ₀+μᵢ^{I}+μᵤ^{U}.

However, in most of cases, the number of users is much greater than the number of items. In short, |UI|>>|I|. Thus, it is ineffective to estimate |U|×k parameters to identify ϕᵤ^{U}. Accordingly, it would be more favorable to apply the regression model to ϕᵤ^{U}, instead of directly estimating ϕᵤ^{U}.

Then,

$${φ}_{u}^{U} \approx \vert {R}_{I} ( u ) {\vert}^{- 1 \text{/} 2} {\sum }_{j ∈ {R}_{I} ( u )} \{ ( {r}_{uj} - {μ}_{uj} ) {x}_{j} + {y}_{j} \} ,$$

wherein xⱼ,yⱼ∈ [symbol] ^{k}. In this case, the number of parameters may be reduced from |U|×k to 2×|I|×k. A model equation under the hybrid technique is as follows:

$${\hat{r}}_{ui} = {μ}_{ui} + {φ}_{i}^{{I}^{′}} [ {\vert {R}_{I} ( u ) \vert}^{- 1 / 2} {\sum }_{j ∈ {R}_{I} ( u )} \{ ( {r}_{uj} - {μ}_{uj} ) {x}_{j} + {y}_{j} \} ]$$

$${μ}_{ui} = {μ}_{0} + {μ}_{i}^{I} + {μ}_{u}^{U}$$

Herein, a parameter estimation method is as shown below.

First of all, μ₀,μᵢ^{I},μᵤ^{U} (u∈U, i∈I) that minimize

$${\sum }_{( u , i ) ∈ R} {\{ {r}_{ui} - {μ}_{0} - {μ}_{i}^{I} - {μ}_{u}^{U} \}}^{2} + {λ}_{U} {\sum }_{u} {μ}_{u}^{{U}^{2}} + {λ}_{I} {\sum }_{i} {μ}_{i}^{{I}^{2}}$$

are estimated, wherein λ_{U} and λ_{I} are tuning parameters. Next, xᵢ,yᵢ,ϕᵢ^{I} (i∈I) parameters. U that minimize

$${\sum }_{( u , i ) ∈ R} {\{ {r}_{ui} - {\hat{r}}_{ui} \}}^{2} + {λ}_{{U}^{2}} {\sum }_{i} ( {‖ {x}_{i} ‖}^{2} + {‖ {y}_{i} ‖}^{2} ) + {λ}_{{I}^{2}} {\sum }_{i} {‖ {φ}_{i}^{I} ‖}^{2}$$

are estimated by substituting the estimated μ₀,μᵢ^{I},μᵤ^{U} into the formula.

Collaborative Filtering Approach by Using Additional Information

A more advanced recommender system methodology uses additional information. In detail, it has an advantage of being capable of giving recommendations even when there are new users or new items, in case the recommender system is implemented based on not only the existing data on preference but also the additional information on users and items. That is, a so-called cold start problem may get solved.

Nearest Neighbor Technique by Using Additional Information

Under the nearest neighbor (NN) technique, information on users and items may be reflected on μᵤᵢ. For convenience of explanation, xᵤ∈ [symbol] ^{p} indicates additional information (e.g., age, gender, etc.) of a user u, and zᵢ∈ [symbol] ^{q} indicates additional information (e.g., a price, a brand name, etc.) on an item i, wherein the additional information is represented quantitatively. It can be understood by those skilled in the art that not only numerical data such as age and a price but also categorical data such as gender and a brand name can be represented quantitatively. Then, the additional information on users and items may be reflected on μᵤᵢ as shown below, and explanation on parameter estimation and prediction of values of preference is omitted because it is same as described above.

$$\begin{matrix}{μ}_{ui} = {μ}_{0} + {μ}_{i}^{I} + {μ}_{u}^{U} \\ = {μ}_{0} + {β}_{0}^{U} + {x}_{u}^{′} {β}^{U} + {β}_{0}^{I} + {z}_{i}^{′} {β}^{I}\end{matrix}$$

Context-Aware Recommender Systems

The aforementioned recommender systems do not consider real situations of users at all. In the real situations, there are variables that affect evaluation of values of preference of the users. For example, they may include the users' feelings, time, etc. In this case, comedy movies may be recommended to a user A who might be in a mood for a good laugh, and romantic movies may be recommended to a user B who has a girlfriend on a weekend evening. As such, if a specific item is given, other variables that could affect users' evaluation may be defined as situations, i.e., contexts. To make recommender systems that could produce much better performance, such situations need to be considered.

Multiverse Recommender System

In case of the conventional recommender systems, preference data are two-dimensional matrices, but recommender systems that consider situations use m+2 dimensional tensors which have users, items, and m situations. The conventional MF technique may be modified and then applied to decompose multi-dimensional tensors, thereby acquire a recommendation model. One of its modifications is high-order singular value decomposition (SVD).

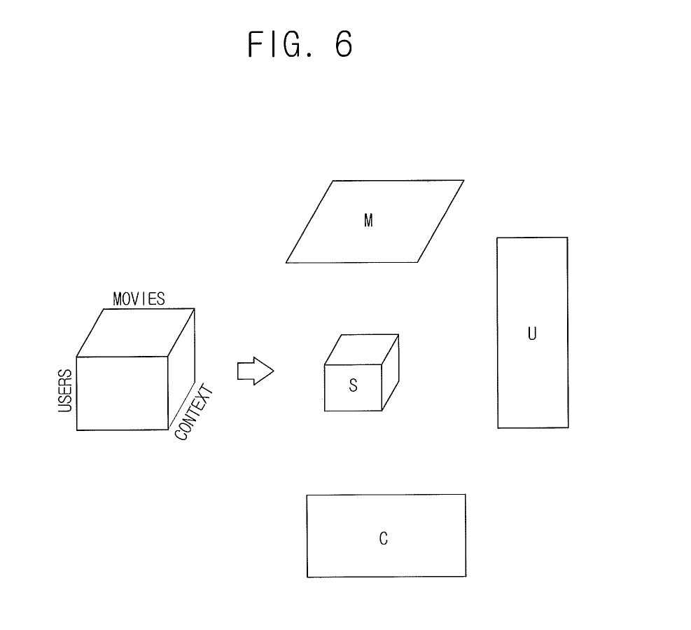

FIG. 6 is a diagram briefly showing a method for decomposing multi-dimensional tensors in a multiverse recommender system. In other words, the high-order SVD is conceptually illustrated. In this case, the tensors are decomposed into tensors of users, movies (i.e., items), and situations. A model equation under the multiverse recommender system is as follows:

$$Y ∈ {ℝ}^{n \times m \times c} , U ∈ {ℝ}^{n \times {d}_{U}} , M ∈ {ℝ}^{m \times {d}_{M}} , C ∈ {ℝ}^{c \times {d}_{C}} and$$

$$S ∈ {ℝ}^{{d}_{U} \times {d}_{M} \times {d}_{C}} , \begin{matrix}{Y}_{n \times m \times c} \approx F \\ = {\sum }_{p = 1}^{{d}_{U}} {\sum }_{q = 1}^{{d}_{M}} {\sum }_{r = 1}^{{d}_{C}} {S}_{pqr} {U}_{p} ⊗ {M}_{q} ⊗ {C}_{r} \\ {F}_{ijk} = S \times {}_{U}^{}{U}{}_{i *}^{} \times {}_{M}^{}{M}{}_{j *}^{} \times {}_{C}^{}{C}{}_{k *}^{}\end{matrix}$$

$$where T = Y \times {}_{U} U is {T}_{ljk} = {\sum }_{i = 1}^{n} {Y}_{ijk} {U}_{ij} .$$

A parameter estimation method under the multiverse recommender system is to estimate parameters that minimize an objective function onto which a penalty function is added. In short, it can be expressed as

$$min {\sum }_{i , j , k} {{D}_{ijk} ( {F}_{ijk} - {Y}_{ijk} )}^{2} + {J}_{λ} ( θ ) ,$$

wherein Dᵢⱼₖ=I(Yᵢⱼₖ is observed), and J_{λ}(θ) is the penalty function.

The shortcoming of the multiverse recommender systems is that they take up a lot of computing time although they have good performance. Generally, matrix computations may consume much calculation resources. In particular, since the systems have to handle even higher-order tensors, much more calculation resources may be consumed.

Recommender System with Factorization Machine

As an alternative to this, a recommender system with a factorization machine may be sometimes used. It guarantees similar performance with an extremely faster computing speed than the multiverse recommender system. In this system, the number of rows of a matrix increases whenever the number of situations increases, without the increase of the tensor dimension, unlike the multiverse recommender system. Therefore, a relatively fast calculation is guaranteed because the dimension of the matrix is kept at two.

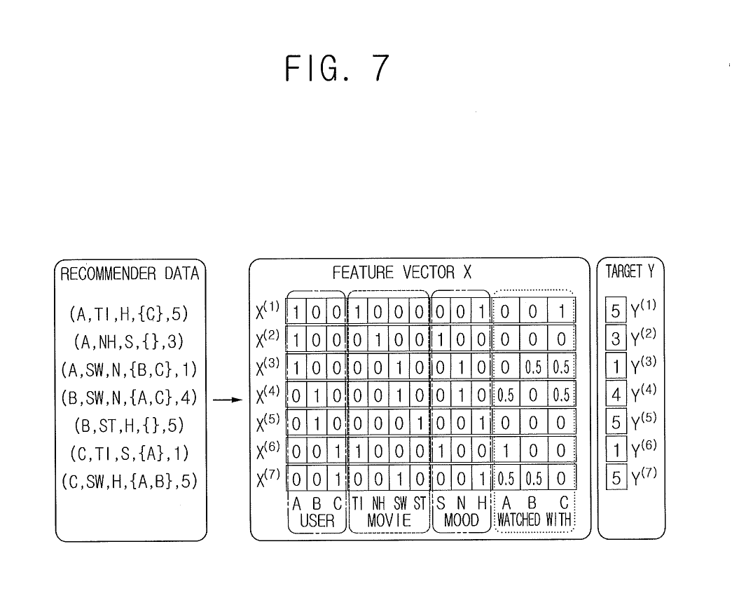

By referring to FIG. 7, an example is explained. FIG. 7 is a diagram showing one example embodiment to which the recommender system with the factorization machine is applied. In this example, there are two situations, which are users' current mood and weighted vectors regarding persons who have watched with the users. For explanation, following notations will be used:

U={Alice, Bob, Charlie};

I={Titanic, Notting Hill, Star Wars, Star Trek};

C1={Sad, Normal, Happy}; and

C2: Weighted vectors regarding persons who have watched with the users.

In other words, U is a set of users, which include Alice A, Bob B, and Charlie C. In addition, I is a set of items, and is a set of movies in this example, which includes Titanic TI, Notting Hill NH, Star Wars SW, and Star Trek ST. C₁ is a set of users' mood, which includes Sad S, Normal N, and Happy H. In FIG. 7, recommender data which are to be used by the recommender system, and feature vectors and targets calculated from the recommender data are illustrated.

A model equation under the recommender system with the factorization machine is as follows:

$$\hat{y} ( x ) = {w}_{0} + {\sum }_{i = 1}^{n} {w}_{i} {x}_{i} + {\sum }_{i = 1}^{n} {\sum }_{j = i + 1}^{n} {w}_{ij} {x}_{i} {x}_{j} , and$$

$${w}_{ij} = 〈 {v}_{i} , {v}_{j} 〉 = {\sum }_{k = 1}^{K} {v}_{ik} {v}_{jk} .$$

The parameter estimation method under the recommender system with the factorization machine is to estimate wₒ,wᵢ,νᵢ that minimize

$${\sum }_{( x , y ) ∈ S}^{ } {( \hat{y} ( x ) - y )}^{2} + {J}_{λ} ( θ ) .$$

Herein, J_{λ}(θ) is a penalty function, wherein θ=(w₀,W,V)′; W=(wᵢ,i=1, . . . , n)′; and V=(νᵢ,i=1, . . . ,n)′.

Personalized Regression

Now, a recommender system in accordance with the present invention will be explained below based on the understanding of the conventional recommender systems as stated above.

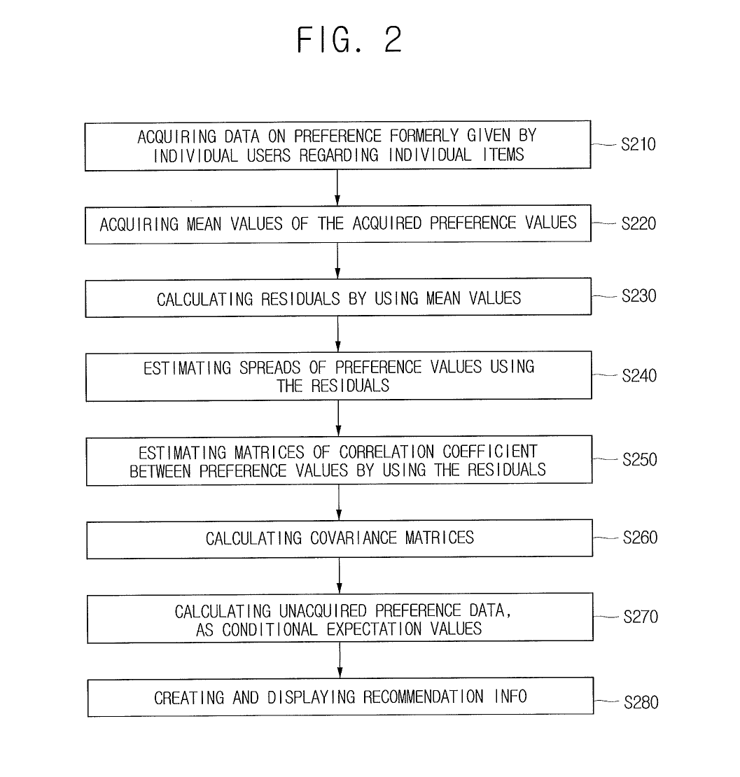

FIG. 2 is a flow chart exemplarily illustrating a method for filtering information to predict values of preference given to one or more items by one or more users in accordance with the present invention.

By referring to FIG. 2, the method of the present invention includes a step S210 of the computing device 100 acquiring data rᵤᵢ on values of preference formerly given by each of individual users u regarding each of individual items i.

Unless otherwise specified, notations used in one example embodiment of this specification are used again in other example embodiments. Just like the notations as used above, Rᵤᵢ indicate random variables that represent the values of the preference given to each of the individual items i by each of the individual users u; rᵤᵢ indicate observed values of Rᵤᵢ; and Rᵤ=(Rᵤᵢ, . . . , R_{uI})′ is a random vector of values of preference of the user u. U indicates a set of the individual users, and I is a set of the individual items, wherein u∈U, i∈I. λ_{U} is a tuning parameter of U and λ_{I} is a tuning parameter of I.

Herein, the Ru are random vectors independent of each other and the mean is assumed to be μu∈ [symbol] |I| and the distribution is assumed to be Σᵤ. On assumption that μᵤ and Σᵤ are known, if preference data are given, conditional expectation values E(Rᵤᵢ|Rᵤⱼ=rᵤⱼ, (u,j)∈R) of Rᵤᵢ are as follows, where μᵤ is a notation representing μᵤ=(μᵤᵢ, i=1, 2, . . . , I):

μᵤᵢ+cᵤᵢ′Σᵤᵢ⁻¹(rᵤ₍₋ᵢ₎−μᵤ₍₋ᵢ₎)

Among the notations in the above-mentioned formula, cᵤᵢ=(σᵤᵢⱼ,(u,j)∈R,j≠i),Σᵤᵢ=(σᵤⱼₖ,j∈Rᵤ^{U},k∈Rᵤ^{U},j≠i,k≠i), and rᵤ₍₋ᵢ₎=(rᵤⱼ,j∈Rᵤ^{U},j≠i),μᵤ₍₋ᵢ₎=(μᵤⱼ,j∈Rᵤ^{U},j≠i) and σᵤᵢⱼ is a (i, j)-th element of Σᵤ. Such conditional expectation values are immediately drawn by applying an equation for a conditional expectation value E(X|Y=y) when (X, Y) regarding two random vectors X and Y follow multivariate normal distribution.

Accordingly, all non-observed values of preference may be predicted by estimating μᵤ and Σᵤ. A model equation under the method of moments approach hereunder is as follows:

Rᵤ˜N_{I}(μᵤ,τᵤ), wherein Rᵤ are independent of each other.

μᵤᵢ+α₀+αᵢ^{I}+αᵤ^{U},Σᵤ=σᵤ²Φ.

wherein α₀ corresponds to a grand mean effect with respect to all values of preference; αᵢ^{I} corresponds to a mean effect with respect to a value of preference for an item i; and αᵤ^{U} corresponds to a mean effect with respect to a value of preference of a user it. Accordingly, the mean μᵤᵢ may be modeled as a sum of α₀, i.e., a grand mean effect regarding all users and items, αᵢ^{I}, i.e., a mean effect regarding the item i, and αᵤ^{U}, i.e., a mean effect regarding the user it. The effect is modeled as such, because means over values of preference may differ by individual users differ and so do means by individual items.

In addition, σᵤ² indicates spreads of the values of the preference by each user it; and ϕⱼₖ, i.e., a (j, k)-th element of Φ, means a correlation coefficient between the values of preference of items j and k.

Now, a parameter estimation in the method of moments approach is applied.

Again, by referring to FIG. 2, the method of the present invention further includes a step S220 of the computing device 100 estimating α₀,αᵢ^{I},αᵤ^{U} that minimize

$${\sum }_{( u , i ) ∈ R}^{ } {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}}$$

and obtaining estimators [symbol] of the mean μᵤᵢ=α₀+αᵢ^{I}+αᵤ^{U} by using the data on the acquired values of preference.

Next, the method of the present invention further includes a step S230 of the computing device 100 calculating residuals μᵤᵢ=α₀=αᵢ^{I}+αᵤ^{U} by using the estimators [symbol] of the means ρᵤᵢ, and, a step S240 of the computing device 100 estimating spreads [symbol] of the values of the preference by each user by using the residuals.

More desirably, the estimation of σᵤ² at the step of S240 may be performed by using estimators

$${\hat{σ}}_{u}^{2} = {\sum }_{j ∈ {R}_{u}^{U}} {( {r}_{uj} - {μ}_{uj} )}^{2} / \vert {R}_{u}^{U} \vert$$

which are sample variances of values of preference of the individual users u, or shrinkage estimators

$${\hat{σ}}_{u}^{2} = \frac{{\sum }_{j ∈ {R}_{u}^{U}} {( {r}_{uj} - {μ}_{uj} )}^{2} + {q}_{σ} {\hat{σ}}^{2}}{\vert {R}_{u}^{U} \vert + {q}_{σ}} ,$$

wherein

$${\hat{σ}}^{2} = {\sum }_{u} {\sum }_{j ∈ {R}_{u}^{U}} {( {r}_{uj} - \overline{r} )}^{2} / {\sum }_{u} \vert {R}_{u}^{U} \vert ; \overline{r} = {\sum }_{u} {\sum }_{j ∈ {R}_{u}^{U}} {r}_{uj} / {\sum }_{u} \vert {R}_{u}^{U} \vert ;$$

and q_{σ} is a tuning parameter.

If the number of items whose values of preference have been evaluated by each user u is small, there are few elements of Rᵤ^{U}. Thus, prediction accuracy drops when σᵤ² are estimated using the sample variances. As another case, when σᵤ² are estimated by the shrinkage estimators, better estimation is achieved since the variances of the estimators are reduced. The corresponding shrinkage estimators may be seen as weighted means over sample variances of the values of preference of the each user u and sample variances of all the values of preference. As the value of the tuning parameter q_{σ} goes toward zero, the estimators approach the sample variances of the values of the preference of each user u; and as the value of the tuning parameter q_{σ} goes to infinity, the estimators approach the sample variances of all the values of preference.

By referring to FIG. 2 again, the method of the present invention further includes a step S250 of the computing device 100 estimating matrices 4) by using the residuals.

Preferably, at the step S250, the whole matrices 4) may be estimated by calculating

$$= \frac{{jk}_{}}{\sqrt{{jj}_{} {kk}_{}}} ,$$

i.e., estimators of ϕⱼₖ which is a (j, k)-th element of the matrices ϕ, using estimators

$${jk}_{} = \frac{{\sum }_{u ∈ {R}_{j}^{I} ⋂ {R}_{k}^{I}} \frac{( {r}_{uj} - {μ}_{uj} ) ( {r}_{uk} - {μ}_{uk} )}{}}{{\sum }_{u} I ( j , k ∈ {R}_{u}^{U} )} , {jk}_{simple}^{} = v {jk}_{} / \sqrt{{n}_{jk}} , or$$

$${jk}_{soft}^{} = {( {jk}_{} - \frac{λ}{\sqrt{{n}_{jk}}} )}_{+} ( {n}_{jk} = {\sum }_{u} I ( j , k ∈ {R}_{u}^{U} ) ) ,$$

wherein I(j,k∈Rᵤ^{U}) is a function that has a value of 1 when j,k∈Rᵤ^{U} and 0 otherwise; and ν is a certain positive number. The [symbol] ⱼₖ are the most basic sample variances, and [symbol] ⱼₖ^{soft} and [symbol] ⱼₖ^{simple} are estimators obtained in the form of shrinkage estimator with respect to σᵤ² to increase prediction accuracy for the reasons as mentioned above. Particularly, [symbol] ⱼₖ^{soft} are called soft thresholding estimators.

Next, the method of the present invention further includes a step S260 of the computing device 100 calculating covariance matrices Σᵤ=σᵤ²Φ and a step S270 of the computing device 100 calculating B(Rᵤᵢ|Rᵤⱼ=rᵤⱼ,(u,j)∈R) as conditional expectation values of Rᵤᵢ, i.e., estimated preference data of a specific user u regarding each item i among the individual items. In general, the estimated preference data herein may be about combinations of the specific user u and the specific item i that are subject of estimation since they are not included in the preference data acquired at the step S210.

If μᵤ and Σᵤ are estimated at the step S260, the estimates of Rᵤᵢ may be obtained by substituting them into an expectation value μᵤᵢ+cᵤᵢ′Σᵤᵢ⁻¹(rᵤ₍₋ᵢ₎−μᵤ₍₋ᵢ₎) at the step S270, which corresponds to a least square estimator, as explained above, but a prediction performance may be much more improved by substituting them into μᵤᵢ=cᵤᵢ′(Σᵤᵢ=λIₙ_{ᵤᵢ})⁻¹(rᵤ₍₋ᵢ₎−μᵤ₍₋ᵢ₎), wherein λ is a tuning parameter;

$${n}_{ui} = {\sum }_{j \neq i} I ( j ∈ {R}_{u}^{U} ) ;$$

and Iₖ is an identity matrix of size of k×k. This may be seen as ridge regression estimators obtained through ridge regression in the regression model. Theoretically, it is well known that the ridge regression estimators have better performance than the least square estimators under a specific situation, e.g., a case where correlations between explanatory variables are high.

At least one of the estimations at the aforementioned steps S220, S240, and S250 may be made by performing the Newton-Raphson method. The Newton-Raphson method was published for the first time in 1685 and simplified explanation was provided in 1690 by Joseph Raphson. Therefore, it has been known to, or may be easily understood by, those skilled in the art. The more detailed explanation will be omitted as it is unnecessary for understanding the present invention.

Lastly, by referring to FIG. 2, the method of the present invention further includes a step S280 of the computing device 100 creating recommendation information which recommends items to the specific user by using the estimated preference data, and displaying the created recommendation information. The preference data are estimated for the purpose of providing recommendation information to users. Such recommendation information, for example, may be information on top n items whose predictive values are highest with respect to the specific user at a particular point of time, wherein n is a certain natural number.

The estimators under the method of moments approach are called MME, i.e., the method of moment estimators, and a model equation under the method of moments approach aforementioned may be modeled as

$${r}_{ui} - {μ}_{ui} = {\sum }_{j ∈ {R}_{u}^{U} , j \neq i} {β}_{ij}^{u} ( {r}_{uj} - {μ}_{uj} ) + {ϵ}_{ui} ,$$

wherein the least square estimators of βᵢⱼ^{u} are same as the MME of cᵤᵢ′Σᵤᵢ⁻¹. In other words, the estimators of βᵢⱼ^{u} may be immediately identified in the aforementioned model through the MME of Σᵤ.

Accordingly, the aforementioned regression model may be interpreted as a modeling of covariance per user between values of preference for two items. Because individual users have their different coefficient values, the model is called a personalized regression algorithm.

The personalized regression algorithm may be more accurate than the NN technique and may easily reflect additional information, context information, etc. Besides, it has a high accuracy on the whole because it provides more accurate estimation of weighted values compared to the global neighborhood technique. In addition, the personalized regression algorithm has a higher predictability than the MF technique because it directly estimates the values of preference and it is much easier to calculate because it does not need repetitive calculations. Accordingly, it may be easily applied even to huge data.

The benefit of this technology is that the recommender system can be applied to large data that was intractable in the past, because large scale computing may be distributed over several computing devices thanks to the applicability of parallel processing by using the regression model.

The present invention has effects of improving predictive power of the recommender system as well as reducing the computational load considerably. In particular, because the moments estimation technique used in the PR method is a method for estimating parameters based on correlation coefficients between values of preference, the estimation is possible even with a single database scan and therefore, it does not require repetitive calculations used in the MF technique.

Besides, the method in accordance with the present invention has effects of easily reflecting additional information, context information, etc. on the corresponding model with an improved scalability of the recommender system.

### INDUSTRIAL AVAILABILITY

The method and the computing device that performs the method can be used to predict values of preference given to items by users and to recommend items depending on the predicted values of preference. For example, it can be used to recommend products a specific person may want to purchase, recommend movies a certain person may want to watch, or recommend applications a particular person may want to use, etc. In addition, it can be used to recommend drinks and foods a specific person may want. That is, it could even be applied to any products, services, and goods if there are corresponding users and corresponding items selectable.

It can be clearly understood based on explanation of the aforementioned example embodiments that the present invention can be achieved from those skilled in the art with combinations of software and hardware or only with hardware. Contributions to objects of technical solutions of the present invention or prior arts may be implemented in a foul′ of program command that may be performed through a variety of computer components and recorded on computer-readable media. The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high-level code that can be used by an interpreter etc., which is executed by a computer. The aforementioned hardware devices can work as more than a software module to perform the action of the present invention and they can do the same in the opposite case. The hardware devices may include processors such as CPU or GPU which are combined with a memory such as ROM or RAM to store program commands, and are configured to run commanders stored on the memory and also a communication part for giving or receiving a signal from or to an external device. Besides, the hardware devices may include keyboards, mouse, and other external input devices to receive commanders written by developers.

As seen above, the present invention has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present invention must not be confined to the explained embodiments, and the following patent claims as well as everything including variants equal or equivalent to the patent claims pertain to the category of the thought of the present invention.

Such equivalents or equivalently all modified ones could include methods mathematically equivalent or logically equivalent that may produce the same result from the method in accordance with the present invention.

What is claimed is:

1. A method for filtering information to predict one or more values of preference given to one or more items by one or more users, comprising steps of:
(a) a computing device acquiring data rᵤᵢ as the value of preference that has been given by each of individual users u regarding each of individual items i;
(b) the computing device obtaining one or more estimators [symbol] of one or more means μᵤᵢ=α₀+αᵢ^{I}+αᵤ^{U} by estimating α₀,αᵢ^{I},αᵤ^{U} (u∈U,i∈I) that minimize
$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ,$$
wherein U indicates a set of the individual users;
I is a set of the individual items;
rᵤᵢ refers to each of observed values of Rᵤᵢ; as random variables that represent the values of the preference given to the each item i by the each user u;
λ_{U} are tuning parameters of U; and
λ_{I} are tuning parameters of I;
(c) the computing device calculating residuals rᵤᵢ− [symbol] by using the estimators [symbol] of the means μᵤᵢ;
(d) the computing device estimating spreads σᵤ² of the values of the preference by individual users by using the residuals;
(e) the computing device estimating matrices Φ by using the residuals;
(f) the computing device calculating covariance matrices Σᵤ=σᵤ²Φ; and
(g) the computing device calculating E(Rᵤᵢ|R^{uj}=rᵢⱼ,(u,j)∈R) which is a conditional expectation value of Rᵤᵢ that is estimated preference data of a specific user u regarding the each item i.

2. The method of claim 1, wherein, at the step of (d), σᵤ² are estimated by using estimators
$${\hat{σ}}_{u}^{2} = {\sum }_{j ∈ {R}_{u}^{U}} {( {r}_{uj} - {μ}_{uj} )}^{2} / \vert {R}_{u}^{U} \vert or {\hat{σ}}_{u}^{2} = \frac{{\sum }_{j ∈ {R}_{u}^{U}} {( {r}_{uj} - {μ}_{uj} )}^{2} + {q}_{σ} {\hat{σ}}^{2}}{\vert {R}_{u}^{U} \vert + {q}_{σ}} ,$$
wherein
$${\hat{σ}}^{2} = {\sum }_{u} {\sum }_{j ∈ {R}_{u}^{U}} {( {r}_{uj} - \overline{r} )}^{2} / {\sum }_{u} \vert {R}_{u}^{U} \vert ; \overline{r} = {\sum }_{u} {\sum }_{j ∈ {R}_{u}^{U}} {r}_{uj} / {\sum }_{u} \vert {R}_{u}^{U} \vert ;$$
and q_{σ} is a tuning parameter.

3. The method of claim 1, wherein, at the step of (e), the matrices Φ are estimated by calculating
$$= \frac{{jk}_{}}{\sqrt{{jj}_{} {kk}_{}}}$$
as an estimator of Φⱼₖ, which is a (j, k)-th element of the Φ by using estimators
$${jk}_{} = \frac{{\sum }_{u ∈ {R}_{j}^{I} ⋂ {R}_{k}^{I}} \frac{( {r}_{uj} - {μ}_{uj} ) ( {r}_{uk} - {μ}_{uk} )}{{2}^{}}}{{\sum }_{u} I ( j , k ∈ {R}_{u}^{U} )} ,$$
$${jk}_{soft}^{} = {( {jk}_{} - \frac{λ}{\sqrt{{n}_{jk}}} )}_{+} ( {n}_{jk} = {\sum }_{u} I ( j , k ∈ {R}_{u}^{U} ) ) , or$$
$${jk}_{simple}^{} = v {jk}_{} / \sqrt{{n}_{jk}} ,$$
wherein I(j,k∈Rᵤ^{U}) is a function that has a value 1 when j,k∈Rᵤ^{U} and 0 otherwise; and ν is a certain positive number.

4. The method of claim 1, wherein, at the step of (g), B(Rᵤᵢ|Rᵤⱼ=rᵤⱼ,(u,j)∈R) as the conditional expectation values of Rᵤᵢ are μᵤᵢ+cᵤᵢ′Σᵤᵢ⁻¹(rᵤ₍₋ᵢ₎−μᵤ₍₋ᵢ₎), wherein cᵤᵢ=(σᵤᵢⱼ,(u,j)∈R,j≠i), Σᵤᵢ=(σᵤⱼₖ,j∈Rᵤ^{U},k∈Rᵤ^{U},j≠i,k≠i), rᵤ₍₋ᵢ₎=(rᵤⱼ,j∈Rᵤ^{U},j≠i), μᵤ₍₋ᵢ₎=(μᵤⱼ,j∈Rᵤ^{U},j≠i).

5. The method of claim 1, wherein estimation at the at least one of the steps of (b), (d), and (e) is made by performing the Newton-Raphson method.

6. The method of claim 1, wherein, at the step of (g), B(Rᵤᵢ|Rᵤⱼ=rᵤⱼ,(u,j)∈R) as the conditional expectation values of Rᵤᵢ are μᵤᵢ+cᵤᵢ′(Σᵤᵢ+λIₙ_{ᵤᵢ})⁻¹(rᵤ₍₋ᵢ₎−μᵤ₍₋ᵢ₎), wherein cᵤᵢ=(σᵤᵢⱼ,(u,j)∈R,j≠i), Σᵤᵢ=(σᵤⱼₖ,j∈Rᵤ^{U},k∈Rᵤ^{U},j≠i,k≠i), rᵤ₍₋ᵢ₎=(rᵤⱼ,j∈Rᵤ^{U},j≠i),μᵤ₍₋ᵢ₎=(μᵤⱼ,j∈Rᵤ^{U},j≠i); λ is a tuning parameter;
$${n}_{ui} = {\sum }_{j \neq i} I ( j ∈ {R}_{u}^{U} ) ;$$
and Iₖ are identity matrices of size of k×k.

7. The method of one of claim 1, wherein at least one of the tuning parameters is obtained through cross-validation.

8. The method of claim 1, further comprising a step of:
(h) the computing device creating recommendation information which is information on recommending items to the specific user by using the estimated preference data and displaying the created recommendation information.

9. The method of claim 8, wherein the recommendation information is information on recommending top n items whose predictive values are highest with respect to a specific selector at a particular point of time and n is a certain natural number.

10. A computing device for filtering information to predict one or more values of preference given to one or more items by one or more users, comprising:
a communication part for acquiring data rᵤᵢ as the value of the preference which has been given by each of individual users a regarding each of individual items i; and
a processor for (i) obtaining estimators [symbol] of one or more means μᵤᵢ=α₀+αᵢ^{I}+αᵤ^{U} by estimating α₀,αᵢ^{I},αᵤ^{U} (u∈U, i∈I) that minimize
$${\sum }_{( u , i ) ∈ R} {\{ {r}_{ui} - {α}_{0} - {α}_{i}^{I} - {α}_{u}^{U} \}}^{2} + {λ}_{U} {\sum }_{u} {α}_{u}^{{U}^{2}} + {λ}_{I} {\sum }_{i} {α}_{i}^{{I}^{2}} ,$$
wherein U indicates a set of the individual users;
I is a set of the individual items;
rᵤᵢ refers to each of observed values of Rᵤᵢ as random variables that represent the values of the preference given to the each item i by the each user u;
λ_{U} are tuning parameters of U; and
λ_{I} are tuning parameters of I;
(ii) calculating residuals rᵤᵢ− [symbol] by using the estimators [symbol] of the means μᵤᵢ;
(iii) estimating spreads σᵤ² of the values of the preference by individual users by using the residuals;
(iv) estimating matrices Φ by using the residuals;
(v) calculating covariance matrices Σu=σᵤ²Φ; and
(vi) calculating B(Rᵤᵢ|Rᵤⱼ=rᵤⱼ,(u,j)∈R) which is a conditional expectation value of Rᵤᵢ that is estimated preference data of a specific user u regarding the each item i.

11. The device of claim 10, wherein the processor estimates σᵤ² by using estimators
$${\hat{σ}}_{u}^{2} = {\sum }_{j ∈ {R}_{u}^{U}} {( {r}_{uj} - {μ}_{uj} )}^{2} / \vert {R}_{u}^{U} \vert or {\hat{σ}}_{u}^{2} = \frac{{\sum }_{j ∈ {R}_{u}^{U}} {( {r}_{uj} - {μ}_{uj} )}^{2} + {q}_{σ} {\hat{σ}}^{2}}{\vert {R}_{u}^{U} \vert + {q}_{σ}} ,$$
wherein
$${\hat{σ}}^{2} = {\sum }_{u} {\sum }_{j ∈ {R}_{u}^{U}} {( {r}_{uj} - \overline{r} )}^{2} / {\sum }_{u} \vert {R}_{u}^{U} \vert ; \overline{r} = {\sum }_{u} {\sum }_{j ∈ {R}_{u}^{U}} {r}_{uj} / {\sum }_{u} \vert {R}_{u}^{U} \vert ;$$
and q_{σ} is a tuning parameter.

12. The device of claim 10, wherein the processor estimates the matrices Φ by calculating
$$= \frac{{jk}_{}}{\sqrt{{jj}_{} }}$$
as estimators of Φⱼₖ, which is a (j, k)-th element of the Φ by using estimators
$${jk}_{} = \frac{{\sum }_{u ∈ {R}_{j}^{I} ⋂ {R}_{k}^{I}} \frac{( {r}_{uj} - {μ}_{uj} ) ( {r}_{uk} - {μ}_{uk} )}{{2}^{}}}{{\sum }_{u} I ( j , k ∈ {R}_{u}^{U} )} , {jk}_{soft}^{} = {( {jk}_{} - \frac{λ}{\sqrt{{n}_{jk}}} )}_{+}$$
$$( {n}_{jk} = {\sum }_{u} I ( j , k ∈ {R}_{u}^{U} ) ) , or {jk}_{simple}^{} = v {jk}_{} / \sqrt{{n}_{jk}}$$
wherein I(j,k∈Rᵤ^{U}) is a function that has a value 1 when j,k∈Rᵤ^{U} and 0 otherwise; and ν is a certain positive number.

13. The device of claim 10, wherein B(Rᵤᵢ|Rᵤⱼ=rᵤⱼ,(u,j)∈R) as the conditional expectation values of Rᵤᵢ are μᵤᵢ+cᵤᵢ′Σᵤᵢ⁻¹(rᵤ₍₋ᵢ₎−μᵤ₍₋ᵢ₎), wherein cᵤᵢ=(σᵤᵢⱼ,(u,j)∈R,j≠i), Σᵤᵢ=(σᵤⱼₖ,j∈Rᵤ^{U},k∈Rᵤ^{U},j≠i,k≠i), rᵤ₍₋ᵢ₎=(rᵤⱼ,j∈Rᵤ^{U},j≠i), and, μᵤ₍₋ᵢ₎=(μᵤⱼ,j∈Rᵤ^{U},j≠i).

14. The device of claim 10, wherein at least one of the estimations is made by performing the Newton-Raphson method.

15. The device of claim 10, wherein B(Rᵤᵢ|Rᵤⱼ=rᵤⱼ,(u,j)∈R) as the conditional expectation values of Rᵤᵢ are μᵤᵢ+cᵤᵢ′(Σᵤᵢ+λIₙ_{ᵤᵢ})⁻¹(rᵤ₍₋ᵢ₎−μᵤ₍₋ᵢ₎), wherein cᵤᵢ=(σᵤᵢⱼ,(u,j)∈R,j≠i), Σᵤᵢ=(σᵤⱼₖ,j∈Rᵤ^{U},k∈Rᵤ^{U},j≠i,k≠i), rᵤ₍₋ᵢ₎=(rᵤⱼ,j∈Rᵤ^{U},j≠i), μᵤ₍₋ᵢ₎=(μᵤⱼ,j∈Rᵤ^{U},j≠i); λ is a tuning parameter;
$${n}_{ui} = {\sum }_{j \neq i} I ( j ∈ {R}_{u}^{U} ) ;$$
and Iₖ are identity matrices of size of k×k.

16. The device of claim 10, wherein at least one of the tuning parameters is obtained through cross-validation.

17. The device of claim 10, wherein the processor creates recommendation information which is information on recommending items to the specific user by using the estimated preference data and displaying the created recommendation information.

18. The device of claim 17, wherein the recommendation information is information on recommending top n items whose individual predictive values are highest with respect to a specific selector at a particular point of time and n is a certain natural number.
